(19) United States
(12) Patent Application Publication
(10) Pub. No.: US 2026/0204271 A1
(43) Pub. Date: Jul. 16, 2026

(54) PLAYBACK SOUND CORRECTION APPARATUS, PLAYBACK SOUND CORRECTION METHOD, AND PROGRAM

(71) Applicant: NIPPON TELEGRAPH AND TELEPHONE CORPORATION, Tokyo (JP)

(72) Inventors: Tatsuya KAKO, Musashino-shi, Tokyo (JP); Shihori KOZUKA, Musashino-shi, Tokyo (JP); Hironobu CHIBA, Musashino-shi, Tokyo (JP); Hiroaki ITO, Musashino-shi, Tokyo (JP); Kenichi NOGUCHI, Musashino-shi, Tokyo (JP)

(73) Assignee: NIPPON TELEGRAPH AND TELEPHONE CORPORATION, Tokyo (JP)

(21) Appl. No.: 19/137,652

(22) PCT Filed: Dec. 21, 2022
(86) PCT No.: PCT/JP2022/047148

§ 371 Date: Jun. 11, 2025

(51) Int. Cl. G10L 21/0208; H04S 7/00

(52) U.S. Cl. CPC G10L 21/0208; H04S 7/30

(57) ABSTRACT

Provided is a playback sound correction apparatus that corrects a playback sound of an open-ear earphone including a speaker and a microphone, the apparatus including: a characteristics measuring sound playback unit configured to play back a characteristics measuring sound from the speaker; a transfer function calculation unit configured to calculate a transfer function from the speaker to the microphone based on a recorded sound of the microphone and the characteristics measuring sound; a correction filter calculation unit configured to calculate an inverse filter of the transfer function as a correction filter; and a playback sound correction unit configured to correct the playback sound with the correction filter.

### TECHNICAL FIELD

The present invention relates to a playback sound correction apparatus, a playback sound correction method, and a program, each of which is capable of improving the stereophonic sound of open-ear earphones.

### BACKGROUND ART

To achieve a stereophonic sound, a conventional technology is for measuring a head related transfer function (HRTF), that is, an impulse response of both ears from a sound source in a specific direction to human ears (dummy head), convolving the impulse response into a specific sound source, and playing back the sound source from headphones or earphones (Non Patent Literature 1). A playback signal that has undergone the processing described above is sound including the influence of the human auricle, and when played back from earphones or headphones, it sounds as if the sound source is played back from the specific direction (stereophonic sound).

### CITATION LIST

### Non Patent Literature

Non Patent Literature 1: Kazuhiro Iida, Acoustical Society of Japan, “Onkyou tekunorojii siriizu 19: toubu dentatsu kansuu no kiso to san jigen onkyou shisutemu eno ouyou [in Japanese] (Acoustic Technology Series No. 19: Fundamentals of Head-related Transfer Function and Applications to Three-Dimensional Acoustic Systems)”, First Edition, Corona Publishing, Mar. 22, 2017,
   <URL: https://www.coronasha.co.jp/np/isbn/97843390113 33/>

### SUMMARY OF INVENTION

### Technical Problem

In the stereophonic sound playback, sound transfer characteristics from an earphone to the user's ear greatly affect a localization sensation of a sound source. In particular, the localization sensation in the elevation angle direction is greatly affected, and in order to enable accurate perception, it is necessary to cancel out the sound transmission characteristics based on the presence of an earphone housing at the ear and to bring the frequency characteristics between a sound desired to be heard and a sound actually heard close to flat.

However, since the speaker in the open-ear earphone is separated from the external acoustic opening, the transmission characteristics are affected by individual differences in the user, such as the auricle shape and the position at which the earphone is located.

Therefore, an object of the present invention is to provide a playback sound correction apparatus capable of improving a stereophonic sound of the open-ear earphone in consideration of individual differences in the user, such as the auricle shape and the position at which the earphone is located.

### Solution to Problem

A playback sound correction apparatus according to the present invention is a playback sound correction apparatus that corrects a playback sound of an open-ear earphone including a speaker and a microphone, which includes: a characteristics measuring sound playback unit, a transfer function calculation unit, a correction filter calculation unit, and a playback sound correction unit.

The characteristics measuring sound playback unit is configured to play back a characteristics measuring sound from the speaker. The transfer function calculation unit is configured to calculate a transfer function from the speaker to the microphone based on a recorded sound of the microphone and the characteristics measuring sound. The correction filter calculation unit is configured to calculate an inverse filter of the transfer function as a correction filter. The playback sound correction unit is configured to correct the playback sound with the correction filter.

### Advantageous Effects of Invention

According to the playback sound correction apparatus of the present invention, it is possible to improve a stereophonic sound of the open-ear earphone in consideration of individual differences in the user, such as the auricle shape and the position at which the earphone is located.

### BRIEF DESCRIPTION OF DRAWINGS

FIG. 1 is a diagram illustrating an example of a conventional open-ear earphone.

FIG. 2 is a diagram illustrating a state in which a microphone for acquiring transmission characteristics is attached to a conventional open-ear earphone.

FIG. 3 is a diagram illustrating transmission characteristics of each microphone attached to an open-ear earphone.

FIG. 4 is a block diagram illustrating a functional configuration example of a playback sound correction apparatus shown in Example 1.

FIG. 5 is a flowchart illustrating exemplified operations of the playback sound correction apparatus shown in Example 1.

FIG. 6 is a block diagram illustrating a functional configuration example of a correction filter calculation unit shown in Example 1.

FIG. 7 is a flowchart illustrating exemplified operations of the correction filter calculation unit shown in Example 1.

FIG. 8 is a diagram illustrating a functional configuration example of a computer.

### DESCRIPTION OF EMBODIMENTS

Hereinafter, an embodiment of the present invention will be described in detail. Note that components having the same functions will be denoted by the same reference numerals, and redundant description will be omitted.

### Example 1

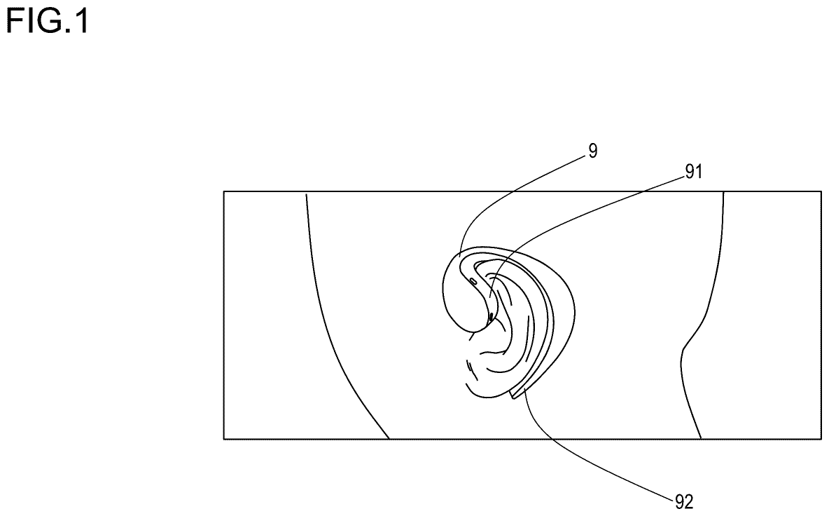

For example, an open-ear earphone 9 illustrated in FIG. 1 has a speaker 91 outside the ear canal and on a side surface of the ear. An open-ear earphone can be used for various purposes other than listening to music; it usually has a microphone in a housing to enable voice communication by being connected to a smartphone or a PC.

When the transmission characteristics are measured, it is ideal that the microphone is disposed at entrance to the ear canal (external acoustic opening); however, in the open-ear earphone, it is not possible to dispose a calling microphone at entrance to the ear canal due to deterioration in call quality and the influence of external sound captured by the ear canal.

The open-ear earphone 9 in the same drawing includes a calling microphone 92 around the auricle (back of the head). Since the open-ear earphone 9 is attached to the outside of the auricle, it is possible to acquire sound having the same tendencies as those of entrance to the ear canal including the influence of resonance generated between the auricle and the speaker with the calling microphone 92 and the speaker 91 disposed on the side surface of the ear.

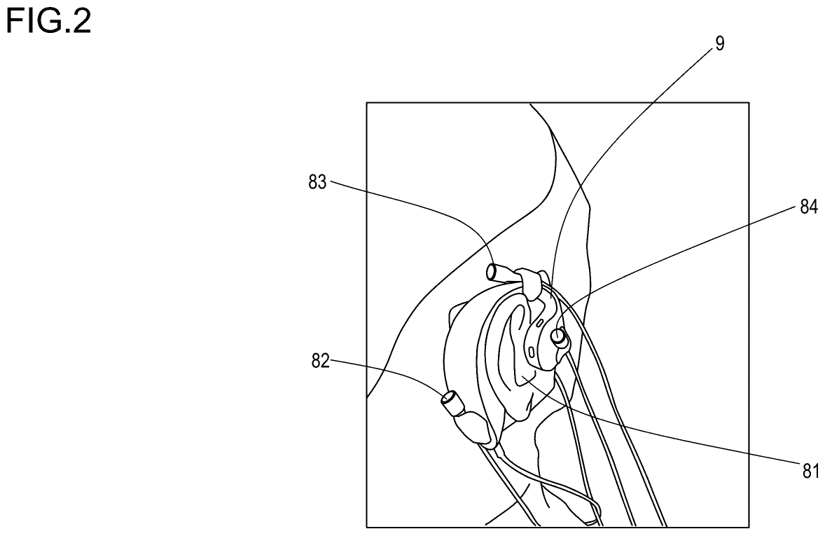

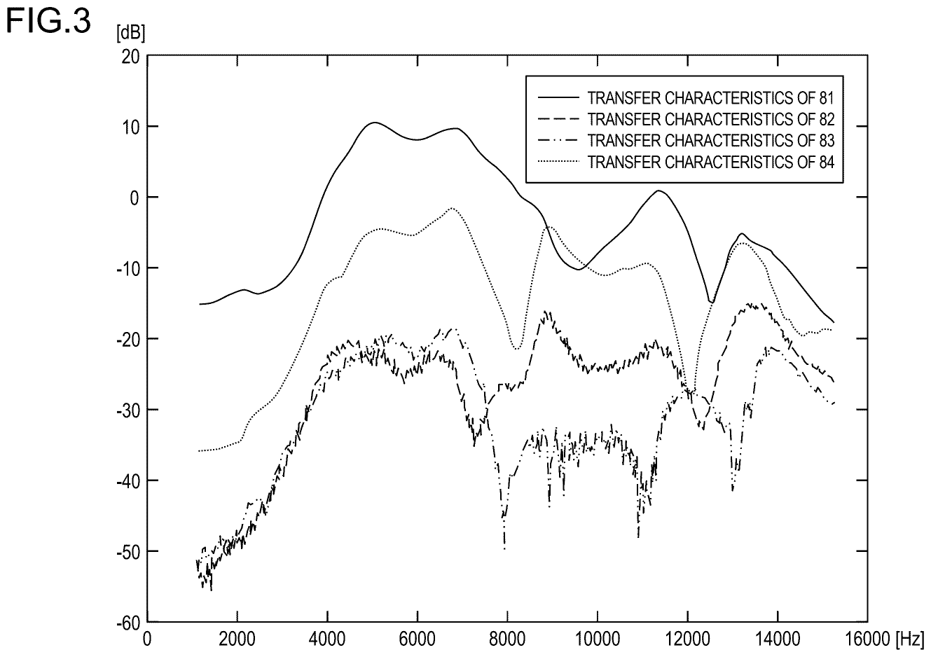

For example, as illustrated in FIG. 2, a total of four experimental microphones were worn on a dummy head: an experimental microphone 81 (hidden behind the ear of the dummy) at a position corresponding to entrance to the ear canal of the dummy head, an experimental microphone 82 around the auricle (occipital side), an experimental microphone 83 around the auricle (parietal side), and an experimental microphone 84 around the auricle (frontal side). The transmission characteristics were measured in each microphone, and the results are summarized in FIG. 3.

As illustrated in FIG. 3, it can be seen that a peak and a notch appear at positions similar to characteristics (solid line) of the microphone 81 disposed at entrance to the ear canal in characteristics (long dashed line) of the microphone 82 disposed around the auricle (occipital side). In this experiment, the microphone 82 has the best characteristics; however, not only the microphone 82 but also the microphone 83 and the microphone 84 have peaks and notches at positions similar to those of the microphone 81, and thus alternatives are available (dashed-dotted line and thin broken line, respectively).

Therefore, it can be understood that, when the calling microphone is disposed at an appropriate position (for example, the position of the microphone 82) of the open-ear earphone, the characteristics acquired from the calling microphone are approximate to the characteristics in a case where the microphone is disposed at entrance to the ear canal. Consequently, it is possible to correct playback sound as if the transfer characteristics acquired using the calling microphone attached to the open-ear earphone had been the same as those acquired based on the microphone attached to entrance to the ear canal to correct the characteristics from the open-ear earphone to entrance to the ear canal taking account of the individual differences in users, such as auricle shape and the position at which the earphone is located, whereby the stereophonic accuracy is improved.

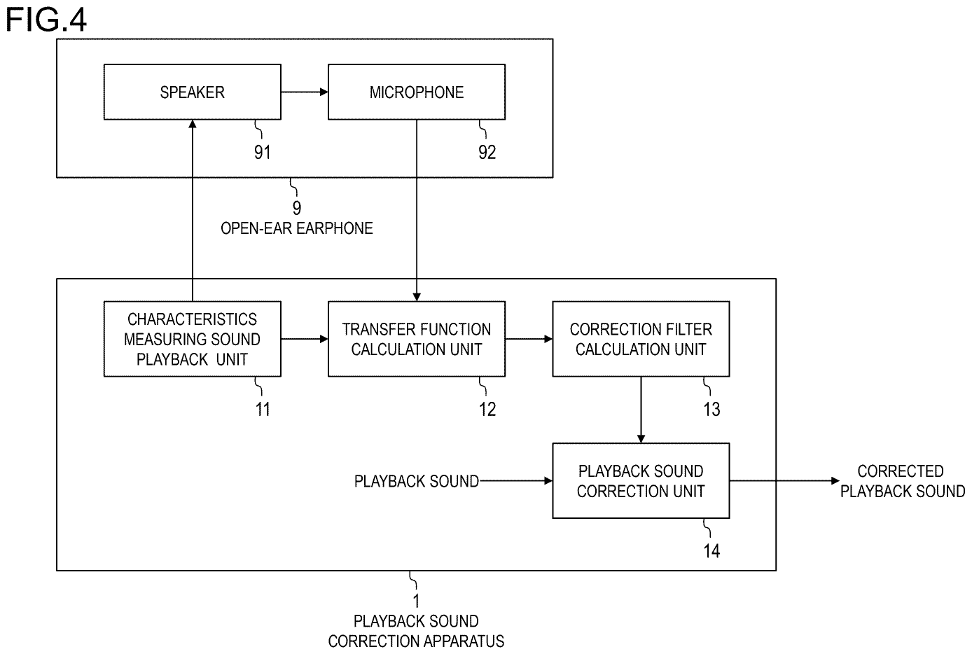

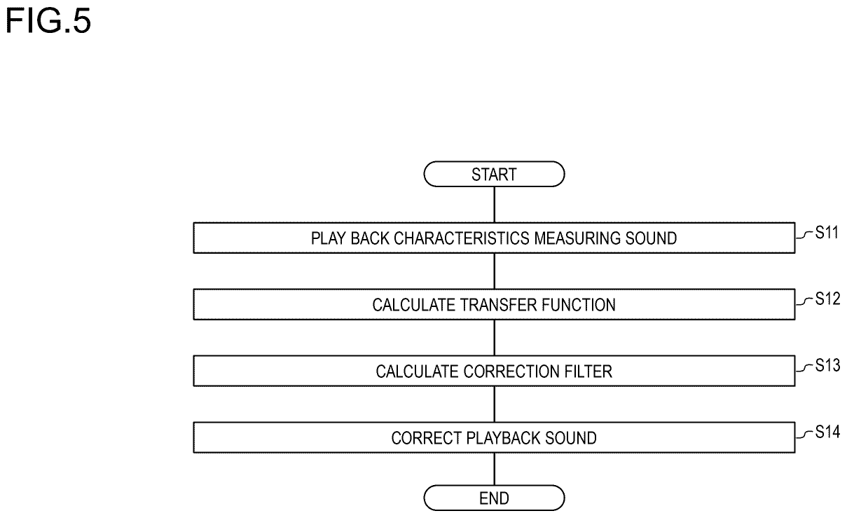

As illustrated in FIG. 4, a playback sound correction apparatus 1 shown in Example 1 includes a characteristics measuring sound playback unit 11, a transfer function calculation unit 12, a correction filter calculation unit 13, and a playback sound correction unit 14, and the open-ear earphone 9 includes a speaker 91 and a microphone 92. Hereinafter, detailed operations of each component of the playback sound correction apparatus 1 will be described with reference to FIG. 5.

### <Characteristics Measuring Sound Playback Unit 11>

The characteristics measuring sound playback unit 11 plays back a characteristics measuring sound from the speaker 91 of the open-ear earphone 9 (S11). For example, a time-stretched-pulse (TSP) signal can be used as a characteristics measuring sound, thereby acquiring an impulse response from the speaker 91 to the microphone 92. The TSP signal is disclosed in, for example, Reference Non Patent Literature 1 below.
(Reference Non Patent Literature 1: Aoki Applied Acoustics. Co., Ltd., “Measuring System of Sound Propagation System by Aoshima Pulse (TSP)”, [online]
   August, 2000, Aoki Applied Acoustics. Co., Ltd., [retrieved on Dec. 14, 2022], Internet <URL: http://www4.fctv.ne.jp/~aokims/tsp2000.html>)

Hereinafter, a specific exemplified method for acquiring the characteristics measuring sound using the TSP signal will be described.

<Method for Acquiring Characteristics Measuring Sound with TSP Signal>

It is preferred to use a method that puts as little burden on the user as possible when acquiring the characteristics measuring sound. For example, at the time of initial setup of the open-ear earphone 9, the TSP signal may be played back when the user wears the open-ear earphone 9.

The TSP signal has a property of increasing the SN ratio by extending the impulse response for a time. Since making a loud sound close to a user's ear is likely to cause discomfort or adverse effects on the user's ear, a method of lengthening a time extension of the TSP signal as much as possible, or a method of measuring multiple times to perform arithmetic averaging to improve the SN ratio can be considered. Since a band that needs to be corrected is a band in a range between 5 kHz and 16 kHz, affecting stereophonic sounds, another method of narrowing down a sweep sound to this limited frequency band and playing back to observe characteristics can be considered.

### <Transfer Function Calculation Unit 12>

The transfer function calculation unit 12 calculates a transfer function from the speaker 91 to the microphone 92 based on a recorded sound of the microphone 92 and the characteristics measuring sound (S12).

In a case where the TSP signal is used as the characteristics measuring sound, the transfer function calculation unit 12 compresses (impulses) and acquires a signal extended by convolving the time-inverted TSP signal. When acquiring with an adaptive filter, the transfer function calculation unit 12 uses a transfer function from the speaker to the microphone obtained when system identification is performed with the adaptive filter.

Further, the characteristics measuring sound playback unit 11 may play back a musical sound, and the transfer function calculation unit 12 may dynamically calculate a transfer function using the adaptive filter during the playback of the musical sound. Hereinafter, a method for automatically measuring transfer characteristics during the musical sound is played back will be described.

### <Method for Automatically Measuring Characteristics During Musical Sound is Played Back>

A method of acquiring acoustic characteristics using a signal of daily music listening rather than acquiring the acoustic characteristics using an observation signal such as a TSP signal or a sweep sound can be implemented with the least burden of the user. For implementation, the transfer function from the speaker 91 to the microphone 92 may be dynamically estimated using the adaptive filter used for howling cancellation or echo cancellation. Accordingly, acoustic characteristics can be acquired from a signal being played back for listening to music.

In a case where a musical sound signal is used, the transfer function calculation unit 12 dynamically estimate the transfer function from the speaker 91 to the microphone 92 using the adaptive filter used for howling cancellation or echo cancellation. A mechanism of echo canceller is disclosed in, for example, Reference Non Patent Literature 2.
(Reference Non Patent Literature 2: ARI Co., Ltd., “Mechanism of Adaptive Echo Canceller”, [online]
   ARI Co., Ltd., [retrieved on Dec. 14, 2022], the Internet <URL: http://www.ari-web.com/artifit/voice/0403.htm>)

### <Correction Filter Calculation Unit 13>

The correction filter calculation unit 13 calculates an inverse filter of the transfer function as a correction filter (S13).

The correction filter calculation unit 13 calculates an inverse filter of the characteristics from the speaker 91 to the microphone 92 acquired by the transfer function calculation. For the inverse filter calculation, “pseudo-inverse filter calculation” described later may be employed. An inverse filter design method described in Reference Non Patent Literature 3 may be also used.
(Reference Non Patent Literature 3: Scharer, Zora; Lindau, Alexander, “Evaluation of Equalization Methods for Binaural Signals,” AES 126th Convention, Audio Engineering Society, 2009 May 1, Paper Number: 7721)

The following is Equation (8) representing the inverse filter disclosed in Reference Non Patent Literature 3:

$${H}_{c} ( k ) = \frac{{D}^{*} ( k ) H ( k )}{H ( k ) {H}^{*} ( k ) + β \cdot B ( k ) {B}^{*} ( k )} \qquad [ Math . 1 ]$$

wherein k denotes a frequency, H_{c}(k) denotes an inverse filter, H and B respectively denote a convolution matrix of the measured transfer function, and B denotes a weighting coefficient determined by three expert listeners.

The correction filter calculation unit 13 may acquire frequencies of a peak and a notch and perform correction using a biquadratic filter.

### <Pseudo Inverse Filter Calculation>

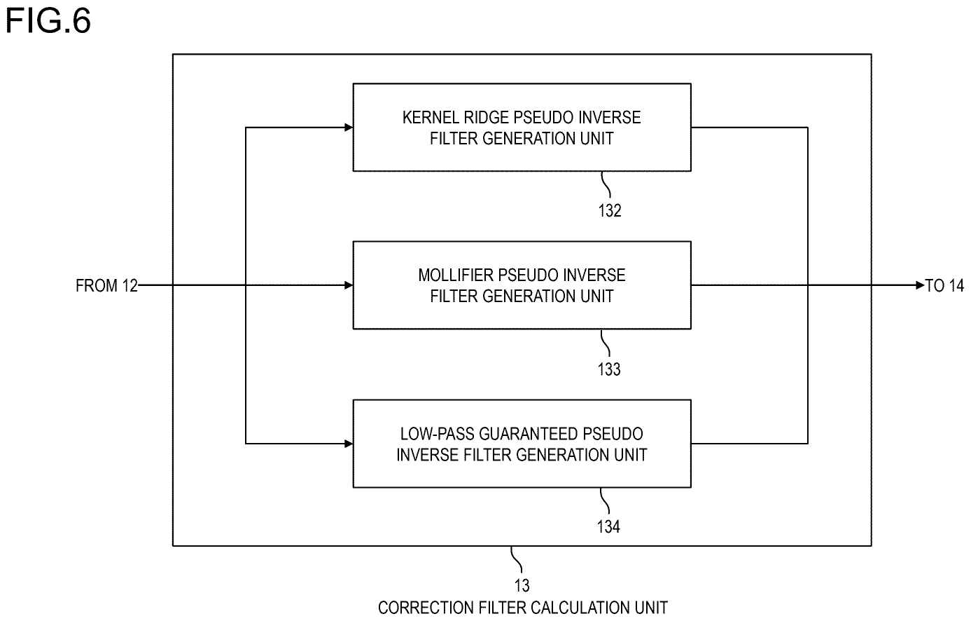

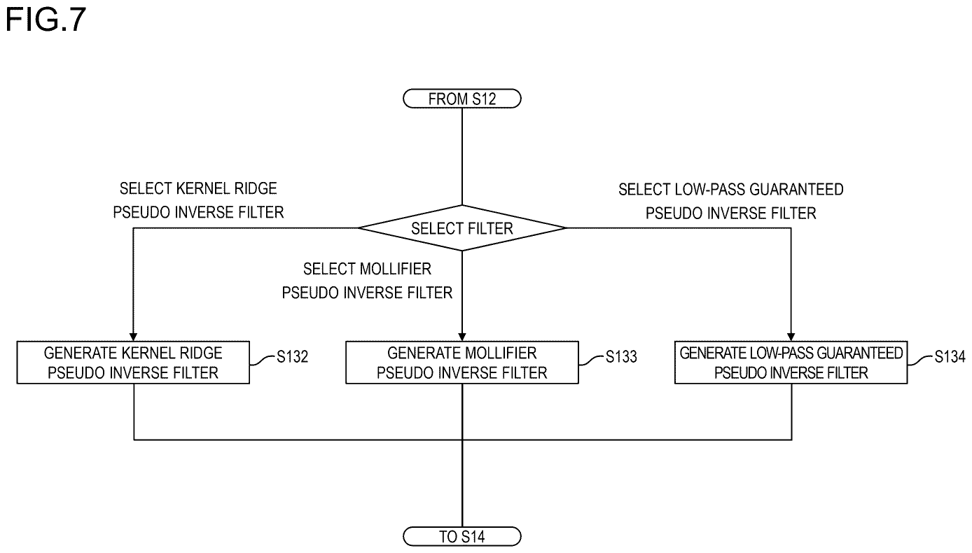

As illustrated in FIG. 6, the correction filter calculation unit 13 as shown in the present example may include all or any of the three pseudo inverse filter generation units 132, 133, and 134. Hereinafter, detailed operations of the pseudo inverse filter generation units 132, 133, and 134 will be described with reference to FIG. 7.

### <<Pseudo Inverse Filter Generation Units 132, 133, and 134>>

The pseudo inverse filter generation units 132, 133, and 134 described below are each characterized by generating a pseudo inverse filter by a function that smooths transfer characteristics from a speaker driver of the open-ear earphone to entrance to the ear canal.

### <Kernel Ridge Pseudo Inverse Filter Generation Unit 132>

The kernel ridge pseudo inverse filter generation unit 132 generates a kernel ridge pseudo inverse filter that is a pseudo inverse filter using the kernel ridge regression (S132).

First, the kernel ridge pseudo inverse filter generation unit 132 detects a peak H(xₚₑₐₖ) and a notch H(x_{notch}) of the transfer characteristics from the open-ear earphone to the ear canal.

$$H ( {x}_{peak} ) , H ( {x}_{notch} ) \qquad [ Math . 2 ]$$

Next, the kernel ridge pseudo inverse filter generation unit 132 acquires the reciprocals of the peak H(xₚₑₐₖ) and the notch H(x_{notch}).

$$1 / H ( {x}_{peak} ) , 1 / H ( {x}_{notch} ) \qquad [ Math . 3 ]$$

Next, the kernel ridge pseudo inverse filter generation unit 132 applies the kernel ridge regression based on the reciprocals of the peak and the notch to generate a kernel ridge pseudo inverse filter.

$$g ( α ) = {( H - W α )}^{T} ( H - W α ) + {λα}^{T} W α \qquad [ Math . 4 ]$$

g(α) is an error function. W represents a matrix having, as an element of the matrix, a value of a kernel function with each data point as an argument for transfer characteristics H from the open-ear earphone to the ear canal. α is a weight when the kernel functions are added. The second term of g(α) is a regularization term, and λ is a weight for regularization. The inverse filter uses i as a data point and adds the “kernel functions w(xᵢ, x)” by a weight αᵢ of to obtain a form close to 1/H.

### <Mollifier Pseudo Inverse Filter Generation Unit 133>

The mollifier pseudo inverse filter generation unit 133 generates a mollifier pseudo inverse filter that is a pseudo inverse filter using a mollifier (S133).

First, the mollifier pseudo inverse filter generation unit 133 applies three types of mollifiers f(x), described below, to transfer characteristics H(x) from the open-ear earphone to the ear canal. The equation described below represents convolution of the mollifier f(x) and the transfer characteristics H(x) from the open-ear earphone to the ear canal, and X is used to represent the convolution.

$${H}_{molified} ( X ) = \int H ( x ) f ( X - x ) dx \qquad [ Math . 5 ]$$

### 1) Gaussian Function

$$f ( x ) = \frac{1}{√ 2 {πσ}^{2}} exp ( - \frac{{x}^{2}}{2 {σ}^{2}} ) \qquad [ Math . 6 ]$$

### 2) Sinc Function

$$f ( x ) = sin ( x ) / x \qquad [ Math . 7 ]$$

### 3) Function Obtained by Smoothing a Trapezoid

$$f ( x ) = \{ \begin{matrix}exp ( - \frac{1}{1 - {\vert x \vert}^{2}} ) & ( \vert x \vert \leq 1 ) \\ 0 & ( \vert x \vert > 1 )\end{matrix} \qquad [ Math . 8 ]$$

The mollifier pseudo inverse filter generation unit 133 generates a mollifier pseudo inverse filter by taking the reciprocal of the transfer characteristics from the open-ear speaker to the ear canal, the transfer characteristics being smoothed by applying the mollifier (S133).

### <Low-Pass Guaranteed Pseudo Inverse Filter Generation Unit 134>

The low-pass guaranteed pseudo inverse filter generation unit 134 takes a moving average of the transfer characteristics from the open-ear earphone to the ear canal, and generates a low-pass guaranteed pseudo inverse filter that is a pseudo inverse filter that ensures passage of a low frequency range of an inverse filter capable of designating regularization strength for each frequency (S134).

First, the low-pass guaranteed pseudo inverse filter generation unit 134 takes a moving average of the transfer characteristics from the open-ear earphone to the ear canal.

Next, the low-pass guaranteed pseudo inverse filter generation unit 134 generates low-pass filter-processed transfer characteristics obtained by applying a low-pass filter to the moving-averaged transfer characteristics, and band-pass filter-processed transfer characteristics obtained by applying a band-pass filter.

Next, the low-pass guaranteed pseudo inverse filter generation unit 134 generates an inverse filter capable of designating regularization strength for each frequency on the basis of the technique disclosed in Non Patent Literature 1 from the band-pass filter-processed transfer characteristics.

Next, the low-pass guaranteed pseudo inverse filter generation unit 134 multiplies the low-pass filter-processed transfer characteristics by a constant so that a value of a high-pass end point of the low-pass filter-processed transfer characteristics matches a value of a low-pass end point of the band-pass filter-processed transfer characteristics.

Next, the low-pass guaranteed pseudo inverse filter generation unit 134 generates the low-pass guaranteed pseudo inverse filter by combining the inverse filter generated from the band-pass filter-processed transfer characteristics with the low-pass filter-processed transfer characteristics multiplied by the constant.

The only processing to which the correction filter calculation unit 13 as shown in the present example is required is processing of selecting one of three pseudo inverse filters above and generating the selected pseudo inverse filter.

### <Playback Sound Correction Unit 14>

The playback sound correction unit 14 corrects the playback sound with the correction filter (S14)

### Modification Example 1

The playback sound correction apparatus 1 may be a PC, a mobile terminal, or a smartphone. As the modification of Example 1, when the playback sound correction apparatus 1 is a smartphone and is wirelessly connected to the open-ear earphone 9, a function to test how the open-ear earphone 9 is worn may be added by application installed in the playback sound correction apparatus 1 (smartphone).

### Advantageous Effects of Playback Sound Correction Apparatuses in Example 1 and Modification Example

According to the playback sound correction apparatuses of Example 1 and Modification Example, it is possible to acquire the transfer characteristics that can be approximated to the transfer characteristics at entrance to the ear canal using the calling microphone disposed at a suitable position around the auricle (position where the external acoustic opening and the peak-notch position are close to each other). Similarly to the transfer characteristics acquired at entrance to the ear canal, the acquired transfer characteristics include individual differences in the user, such as the auricle shape and the position at which the earphone is located. Therefore, by generating the inverse filter (correction filter) on the basis of the transfer characteristics and correcting the playback sound, it is possible to improve the stereophonic sound of the open-ear earphone in consideration of the individual differences in users, such as the auricle shape and the position at which the earphone is located.

### <Appendix>

The apparatus according to the present invention includes, for example, an input unit that can be connected to, for example, a keyboard as a single hardware entity, an output unit that can be connected to, for example, a liquid crystal display, a communication unit that can be connected to a communication device (e.g., a communication cable) capable of communicating with the outside of the hardware entity, a central processing unit (CPU which may include a cache memory or a register), a RAM or a ROM which is a memory, an external storage device as a hard disk, and a bus that connects the input unit, the output unit, the communication unit, the CPU, the RAM, the ROM, and the external storage device so that data can be exchanged therebetween. A device (drive) that can write and read data in and from a recording medium such as a CD-ROM may be provided in the hardware entity, as necessary. Examples of a physical entity including such a hardware resource include a general-purpose computer.

The external storage device of the hardware entity stores a program that is required for implementing the functions described above, data that is required for processing of the program, and the like (the program may be stored, for example, in a ROM as a read-only storage device instead of the external storage device). Moreover, data obtained by processing of the program is appropriately stored in a RAM or an external storage device.

In the hardware entity, each program stored in the external storage device (or ROM or the like) and data required for processing of each program are read into a memory as necessary, and are appropriately interpreted and processed by the CPU. As a result, the CPU implements a predetermined function (each component referred to as “ . . . unit” or “means for . . . ”).

The present invention is not limited to the embodiment described above, and can be appropriately modified without departing from the gist of the present invention. Moreover, the processing described in the above embodiment may be executed not only in time-series according to the described order, but also in parallel or individually according to the processing capability of the device that executes the processing or as necessary.

As described above, in a case where the processing function of the hardware entity (the device according to the present invention) described in the above embodiment is implemented by a computer, processing content of the function of the hardware entity is described by a program. In addition, the computer executes the program, and thus the processing function of the hardware entity is implemented on the computer.

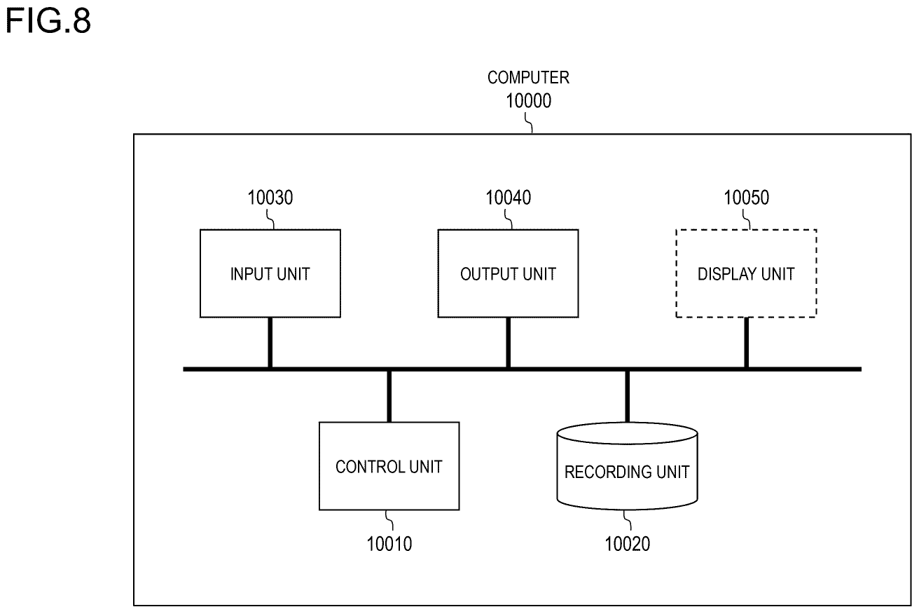

The above-described various types of processing can be performed by causing a recording unit 10020 of a computer illustrated in FIG. 8 to read a program for executing each step of the method described above and causing a control unit 10010, an input unit 10030, an output unit 10040, and the like to operate.

The program describing the processing content may be recorded in a computer-readable recording medium. The computer-readable recording medium may be any recording medium such as a magnetic recording device, an optical disk, a magneto-optical recording medium, or a semiconductor memory, for example. Specifically, for example, a hard disk device, a flexible disk, or a magnetic tape can be used as the magnetic recording device, a digital versatile disc (DVD), a DVD random access memory (DVD-RAM), a compact disc read only memory (CD-ROM), or a CD recordable/rewritable (CD-R/RW) can be used as the optical disk, a magneto-optical disc (MO) can be used as the magneto-optical recording medium, an electrically erasable and programmable-read only memory (EEP-ROM) can be used as the semiconductor memory.

Moreover, distribution of the program is performed by, for example, selling, transferring, or renting a portable recording medium such as a DVD or a CD-ROM on which the program is recorded. Furthermore, a configuration in which the program is stored in a storage device in a server computer and the program is distributed by transferring the program from the server computer to other computers via a network may also be employed.

For example, the computer that executes such a program first temporarily stores the program recorded in a portable recording medium or the program transferred from the server computer in the storage device of the own computer. Then, when executing processing, the computer reads the program stored in the recording medium of its own and executes the processing according to the read program. In addition, as another mode of executing the program, the computer may read the program directly from the portable recording medium and execute the processing according to the program, or may sequentially execute processing according to a received program every time the program is transferred from the server computer to the computer. In addition, the above-described processing may be executed by a so-called application service provider (ASP) type service that implements a processing function only by an execution instruction and result acquisition without transferring the program from the server computer to the computer. Note that the program in the present embodiment includes information used for processing by an electronic computer and equivalent to the program (data which is not a direct command to the computer but has property that defines processing of the computer).

Moreover, although the hardware entity is configured by executing a predetermined program on a computer in the embodiment, at least some of the processing content may be implemented by hardware.

1. A playback sound correction apparatus that corrects a playback sound of an open-ear earphone including a speaker and a microphone, the apparatus comprising:
processing circuitry configured to
play back characteristics measuring sound from the speaker;
calculate a transfer function from the speaker to the microphone based on recorded sound of the microphone and the characteristics measuring sound;
calculate an inverse filter of the transfer function as a correction filter; and
correct the playback sound with the correction filter.

2. The playback sound correction apparatus according to claim 1, wherein
the characteristics measuring sound is a TSP sound.

3. The playback sound correction apparatus according to claim 1,
processing circuitry configured to
play back a musical sound, and
dynamically calculate a transfer function using an adaptive filter while the musical sound is played back.

4. A playback sound correction method executed by a playback sound correction apparatus that corrects a playback sound of an open-ear earphone including a speaker and a microphone, the method comprising:
playing back characteristics measuring sound from the speaker;
calculating a transfer function from the speaker to the microphone based on a recorded sound of the microphone and the characteristics measuring sound;
calculating an inverse filter of the transfer function as a correction filter; and
correcting the playback sound with the correction filter.

5. A non-transitory computer-readable storage medium storing a program for causing a computer to execute the playback sound correction method according to claim 4.
